(19) United States
(12) Patent Application Publication
(10) Pub. No.: US 2019/0314916 A1
(43) Pub. Date: Oct. 17, 2019

(54) BRAZING FURNACE AND ALUMINUM-MATERIAL BRAZING METHOD

(71) Applicant: UACJ Corporation, Tokyo (JP)

(72) Inventors: Yasunaga ITOH, Tokyo (JP); Shoichi SAKODA, Tokyo (JP)

(21) Appl. No.: 16/472,528

(22) PCT Filed: Nov. 28, 2017
(86) PCT No.: PCT/JP2017/042646

§ 371 Date: Jun. 21, 2019

(30) Foreign Application Priority Data
Dec. 26, 2016 (JP) 2016-251240

(51) Int. Cl. B23K 1/008; B23K 1/19

(52) U.S. Cl. CPC B23K 1/008; B23K 31/02; B23K 1/19

(57) ABSTRACT

Provided are a brazing furnace (1) and a brazing method in which brazing-joint quality can be easily stabilized in brazing with a reduced applied-amount of flux or in brazing without using flux. The brazing furnace (1) is configured to be used for brazing an object to be processed (100) composed of an aluminum material. The brazing furnace (1) includes a brazing chamber (2) equipped with heating apparatuses (21) that heat the object to be processed (100) to the brazing temperature, an inert gas supply apparatus (3) that supplies an inert gas in to the brazing chamber (2), and a dehumidifying apparatus (4) that is interposed between the inert gas supply apparatus (3) and the brazing chamber (2) and performs dehumidification of the inert gas.

### TECHNICAL FIELD

The present invention relates to a brazing furnace and to an aluminum-material brazing method for brazing an aluminum material.

### BACKGROUND ART

For example, aluminum products such as heat exchangers and machine parts are composed of a number of components made of an aluminum material (including aluminum and aluminum alloys, the same shall be applied hereinafter.) The CAB (controlled-atmosphere brazing) method, which performs brazing by applying a fluoride-based flux to an object to be processed and then heating the object to be processed in an inert gas atmosphere, is generally used as an aluminum-product brazing method.

Nevertheless, in the CAB method, flux and/or flux residue adhere(s) to the surface of an aluminum after the brazing is complete. The flux and/or flux residue may cause a problem depending on the usage of the aluminum products. For example, in an aluminum heat exchanger on which electronic parts are mounted, there is a risk that problems will occur, during its manufacture, such as the degradation of surface treatability due to flux residue. Further, for example, in a water-cooled heat exchanger, there is a risk that problems will occur, such as clogging of a refrigerant flow path due to flux or the like. Still further, to remove flux and flux residue, it is necessary to perform a pickling treatment; in recent years, the cost burden for that treatment is being viewed as a problem.

Accordingly, to reduce or avoid these problems associated with the use of flux, application of brazing methods with a reduced amount of flux applied to a join part and so-called fluxless-brazing methods in which brazing is performed without applying flux to the surface of a join part in an inert gas atmosphere (for example, Patent Document 1) have been investigated. However, in these brazing methods, it is known from experience that brazeability tends to deteriorate when the humidity in the atmosphere is relatively high. Degradation of brazeability also occurs when high-purity nitrogen gas, which is being produced by vaporizing liquid nitrogen, is supplied into the brazing furnace. Therefore, it was believed that degradation of brazeability is caused by an increase of moisture that is brought into the furnace from the outside along with an increase of the humidity in the atmosphere.

The moisture that is brought into the furnace involves a variety of types of ways, such as outside air that will be unavoidably introduced when the object to be processed and the jig, etc. for fixing it are placed in the furnace, moisture absorbed in the object to be processed, or the like. Therefore, in order to reduce the moisture brought into the furnace from the outside in such types of ways, a brazing method has been proposed (Patent Document 2) in which the object to be processed is preheated in a reduced-pressure atmosphere and is brazed after the moisture adhered to the object to be processed has been vaporized.

In addition, techniques that reduce the oxygen concentration in the brazing furnace by a method (Patent Document 3), in which at least part of the inner wall of a brazing furnace is formed of a carbonaceous material and oxygen in the furnace is reacted with the carbonaceous material to convert the oxygen into carbon dioxide, by a method (Patent Document 4), in which an inert gas is supplied to an oxygen pump equipped with a solid electrolyte body having oxygen ion conductivity, and a voltage is applied to this solid electrolyte body, etc., also have been proposed.

### PRIOR ART LITERATURE

### Patent Documents

Patent Document 1

Japanese Laid-open Patent Publication H10-180489

Patent Document 2

Japanese Laid-open Patent Publication 2016-083699

Patent Document 3

Japanese Laid-open Patent Publication 2007-319924

Patent Document 4

Japanese Laid-open Patent Publication 2014-217844

### SUMMARY OF THE INVENTION

### Problems to be Solved by the Invention

Nevertheless, in actual fact, when brazing is performed with a reduced applied-amount of flux or without applying flux, brazeability deteriorates in some cases even if the moisture brought in from outside and/or the oxygen concentration in the brazing atmosphere are/is reduced by the techniques of Patent Documents 2-4.

The present invention has been made in view of this background and it is an object of the present invention to provide a brazing furnace and a brazing method in which brazing-joint quality can be easily stabilized in brazing with a reduced applied-amount of flux or in brazing without using flux.

### Means for Solving the Problems

One aspect of the present invention is a brazing furnace used in brazing of an object to be processed composed of an aluminum material, including:

a brazing chamber equipped with a heating apparatus that heats the object to be processed to a brazing temperature;

an inert gas supply apparatus that supplies an inert gas into the brazing chamber; and

a dehumidifying apparatus that is interposed between the inert gas supply apparatus and the brazing chamber, and performs dehumidification of the inert gas.

Another aspect of the present invention is a method for brazing an aluminum material in which an object to be processed composed of an aluminum material is brazed in an inert gas atmosphere, the method including:

dehumidifying an inert gas;

making the surroundings of the object to be processed an inert gas atmosphere by supplying the dehumidified inert gas; and

heating the object to be processed to a brazing temperature in the inert gas atmosphere and brazing the object.

In conventional brazing, a nitrogen gas produced by vaporizing liquid nitrogen has been used as the inert gas, as mentioned above. Because such nitrogen gas already has sufficient purity, it has been recognized that degradation of brazeability was primarily caused by oxygen and moisture brought in from outside of the furnace, such as the atmosphere that comes in from the outside of the furnace, the moisture absorbed in the object to be processed, or the like.

However, nitrogen gas produced by vaporizing liquid nitrogen typically has a dew point of approximately −76° C., and contains a small amount of moisture approximately at 1 vol. ppm. As a result of earnest investigation, the present inventors found that degradation of brazeability is caused by adding the trace amount of moisture intrinsically contained in the nitrogen gas to the moisture brought in from outside of the furnace.

The above-mentioned brazing furnace includes the dehumidifying apparatus that performs dehumidification of the inert gas supplied from the inert gas supply apparatus, and is configured such that the dehumidified inert gas can be supplied into the brazing chamber. Accordingly, the inert gas is not supplied from the inert gas supply apparatus directly to the brazing chamber, but rather is supplied to the brazing chamber after dehumidification is performed, so that it is possible to reduce the total amount of moisture brought into the brazing chamber from the outside and moisture intrinsically contained in the inert gas more than in the past. In this way, it is possible to curtail degradation of brazeabiity and to form a satisfactory brazing joint in brazing with a reduced applied-amount of flux or in brazing without using flux.

In addition, according to the above-mentioned brazing furnace, it is possible to mitigate the effects on brazeability owing to the atmosphere outside the brazing furnace, the storage environment of the object to be processed, etc. Therefore, by using the brazing furnace, it is possible to reduce the amount of moisture brought into the brazing furnace to thereby form a satisfactory brazing joint even in, for example, high-temperature, high-humidity regions, seasons, or in cases in which strict control of the storage environment of the material to be processed is difficult.

### BRIEF DESCRIPTION OF THE DRAWINGS

FIG. 1 is a sectional view showing a main part of a brazing furnace according to working example 1.

FIG. 2 is a sectional view showing a main part of a brazing furnace according to working example 2, further including a preheating chamber.

FIG. 3 is a sectional view showing a main part of a brazing furnace according to working example 3, further including a cooling chamber.

FIG. 4 is a perspective view of an outer fin test specimen for evaluation of brazeability, according to experimental example 1.

FIG. 5 is a perspective view of a cup test specimen for evaluation of brazeability, according to experimental example 2.

FIG. 6 is a sectional view viewed along arrows VI-VI in FIG. 5.

### MODE(S) FOR CARRYING OUT THE INVENTION

In the brazing furnace, as long an inert gas can be supplied to the brazing chamber via a dehumidifying apparatus, any type of apparatus may be used as the inert gas supply apparatus. For example, an apparatus that supplies an inert gas formed by vaporizing liquid nitrogen or the like, an apparatus that supplies an inert gas from a cylinder filled with the inert gas, or the like can be used as the inert gas supply apparatus. Also, in case nitrogen is used as the inert gas, it is possible to use an apparatus, which separates nitrogen in the atmosphere using a cryogenic separation method and supplies the nitrogen gas that was generated in situ, as the inert gas supply apparatus.

A non-oxidative gas such as nitrogen gas, helium gas, argon gas, or the like can be used as the inert gas to be supplied from the inert gas supply apparatus. In a mass-production facility, high-purity nitrogen gas formed by vaporizing liquid nitrogen is typically used from the viewpoint of cost and availability. Because such a nitrogen gas has a dew point of approximately −76° C., which is already sufficiently low, the number of dehumidification instances can be reduced and the dehumidifying apparatus can be simplified.

The inert gas is supplied from the inert gas supply apparatus to the dehumidifying apparatus. Then, dehumidification of the inert gas is performed in the dehumidifying apparatus. The dehumidifying apparatus may be appropriately selected for use from among known dehumidifying apparatuses in consideration of the dew point of the inert gas and the dehumidification capability of the apparatus. For example, an apparatus that removes moisture that was condensed by isothermally compressing the inert gas using a compressor and thereby increasing the relative humidity, an apparatus that selectively removes moisture vapor by contacting the inert gas compressed by a compressor with a vapor permeable membrane, an apparatus in which moisture is absorbed into a moisture absorbent by contacting the inert gas with the moisture absorbent, or the like can be used as the dehumidifying apparatus. These dehumidifying apparatuses may be use singly or in combination.

The dehumidifying apparatus is preferably configured such that the dew point of the inert gas can be set to −80° C. or less. By setting the dew point of the inert gas to such an extremely low temperature, the effect of moisture brought in from the outside can be reduced. Consequently, in brazing with a reduced applied-amount of flux, or in brazing without using flux, degradation of brazeability can be curtailed more effectively.

The dehumidifying apparatus preferably includes a moisture absorbent that absorbs moisture in the inert gas by contacting it with the inert gas. This type of dehumidifying apparatus has an extremely high dehumidification capability, so that the dew point of a high-purity inert gas, such as nitrogen gas formed by vaporizing liquid nitrogen, can be further lowered. Therefore, by using a dehumidifying apparatus equipped with a moisture absorbent, degradation of brazeability can be curtailed more effectively.

For example, an adsorption tower, which is packed with a drying agent, such as silica gel, metal silicate, or zeolite, a rotor that holds such a drying agent, or the like can be used as the moisture absorbent. In the case of the former, dehumidification can be performed by passing the inert gas through the adsorption tower. In the case of the latter, dehumidification can be performed by contacting the inert gas with the rotor that is being rotated.

The dehumidifying apparatus may further include a plurality of gas flow paths connected in parallel with each other, a moisture absorbent disposed in each gas flow path, and a flow path switch that switches the supply and the stoppage of the inert gas to each gas flow path. The dehumidification capability of a moisture absorbent may deteriorate due to various reasons, for example, due to the moisture absorbent becoming nearly saturated with absorbed moisture. In such a case, a dehumidifying apparatus, which is equipped with a flow path switch, can stop the supply of the inert gas to that moisture absorbent, and can continuously supply the inert gas to another moisture absorbent. In this way, replacement, etc. of the moisture absorbent, in which the dehumidification capability has decreased, can be performed while continuing the dehumidification of the inert gas. Consequently, maintainability of the brazing furnace can be further improved.

In addition, the dehumidifying apparatus preferably further includes a regenerating device that removes moisture, which has been absorbed into a moisture absorbent, from that moisture absorbent. By removing the moisture from the moisture absorbent using the regenerating device, the dehumidification capability of the moisture absorbent can be restored. The replacement frequency of the moisture absorbent can be reduced thereby and thus the running cost of the brazing furnace can be reduced. For example, a device that desorbs moisture in the moisture absorbent by degassing while heating the moisture absorbent, a device that desorbs moisture in the moisture absorbent by supplying dry gas to the moisture absorbent, a device that desorbs moisture in the moisture absorbent by simultaneously performing warming of the moisture absorbent and introduction of dry gas, or the like can be used as the regenerating device.

The brazing furnace may be equipped with only a brazing chamber, or may further include a chamber that communicates with the brazing chamber. For example, the brazing furnace may further include a preheating chamber connected to the brazing chamber and equipped with a preheating device that preheats the object to be processed to a temperature lower than the brazing temperature; a preheating pump that depressurizes the interior of the preheating chamber, and a re-pressurizing gas supply apparatus that supplies the inert gas for re-pressurizing the interior of the preheating chamber after the pressure reduction.

In this case, in the state in which the object to be processed has entered into the preheating chamber, the brazing furnace can depressurize the interior and perform preheating of the object to be processed. Furthermore, by performing preheating of the object to be processed in the reduced-pressure atmosphere, evaporation of moisture adhered to the object to be processed and to the jig can be promoted. As a result, the amount of moisture brought into the brazing chamber can be reduced more than the case in which preheating is not performed.

In addition, with regard to the brazing furnace, after the preheating has been completed, an inert gas can be supplied into the preheating chamber and re-pressurization of the preheating chamber can be performed. Thus, it is possible to avoid exposing the object to be processed and the jig, after the preheating, to the atmosphere; as a result, re-adhesion of moisture thereto can be avoided. Further, by re-pressurizing the preheating chamber using the inert gas, it can be avoided that the atmosphere will flow into the brazing chamber when the object to be processed is moved from the preheating chamber into the brazing chamber.

As mentioned above, the brazing furnace, which is further equipped with the preheating chamber, can further reduce the amounts of oxygen and moisture brought in from outside the furnace. Therefore, by using the brazing furnace in brazing with a reduced applied-amount of flux or in brazing without using flux, it is possible to mitigate the effects on brazeability owing to the storage environment and usage conditions of the object to be processed, the jig, and the filler material, as well as fluctuations in the environment outside the furnace and the like. As a result, the brazing furnace can easily stabilize brazing joint quality, and can curtail degradation of brazeability, the occurrence of joint failures, and the like.

The brazing furnace is preferably configured such that the pressure inside the preheating chamber can be reduced to 100 Pa or less. By setting the pressure inside the preheating chamber to 100 Pa or less, the removal of moisture and the like during preheating can be further promoted. As a result, the time required for preheating can be further shortened.

The preheating chamber is preferably configured such that the temperature of the object to be processed can be set to greater than 200° C. In this case, evaporation of moisture adhered to the object to be processed or the like can be promoted, and the amount of moisture brought into the furnace can be reduced more. In addition, in case residues of machining oil or the like are adhered to the object to be processed and/or the jig, the removal of these residues can be also promoted.

In addition, the brazing furnace may further include a cooling chamber connected to the brazing chamber and a cooling gas supply apparatus that supplies an inert gas into the cooling chamber. By cooling the object to be processed in the inert gas atmosphere in the cooling chamber, unnecessary oxidation of the object to be processed can be curtailed. In addition, in this case, because the cooling chamber is filled with inert gas, it is possible to impede the atmosphere from flowing into the brazing chamber from the cooling chamber.

According to the brazing furnace as mentioned above, the object to be processed, which is composed of an aluminum material, can be brazed as follows.

Specifically, the brazing can be performed by:

dehumidifying an inert gas;

making the surroundings of the object to be processed an inert gas atmosphere by supplying the dehumidified inert gas; and

heating the object to be processed to the brazing temperature in the inert gas atmosphere and brazing the object.

The brazing may be performed by using an object to be processed that has been precoated with a fluoride-based flux on a portion to be brazed, or may also be performed by using an object to be processed that has not been precoated with a fluoride-based flux on a portion to be brazed. In the case of the former, the applied amount of the fluoride-based flux may be set to 2 g/m² or less. According to the brazing method as mentioned above, satisfactory brazing can be performed in either case of brazing with a reduced applied-amount of flux, or brazing without using flux.

### Working Example 1

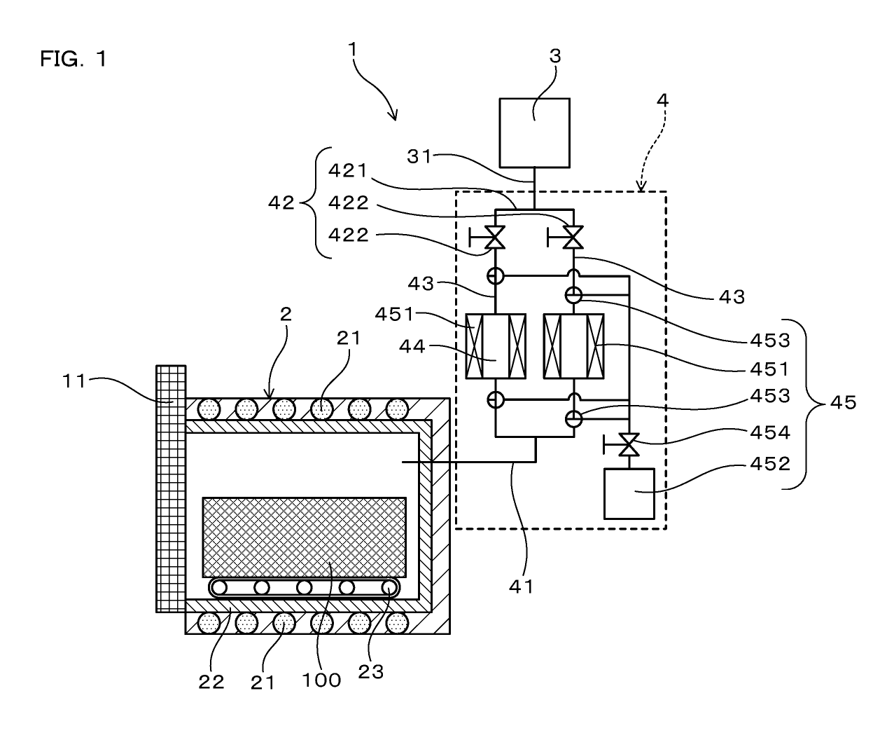

A working example of the brazing furnace will be explained with reference to the drawings. The brazing furnace 1 of the present example is configured to be used for brazing an object to be processed 100, which is composed of an aluminum material. As shown in FIG. 1, the brazing furnace 1 includes a brazing chamber 2 equipped with heating apparatuses 21 that heat the object to be processed 100 to a brazing temperature, an inert gas supply apparatus 3 that supplies an inert gas into the brazing chamber 2, and a dehumidifying apparatus 4 that is interposed between the inert gas supply apparatus 3 and the brazing chamber 2 and dehumidifies the inert gas.

The brazing furnace 1 of the present example is configured such that the object to be processed 100 can be placed inside the furnace through an entrance/exit provided in the brazing chamber 2, and can be taken out of the furnace. The entrance/exit of the brazing chamber 2 is provided with a front door 11, which is capable of opening and closing. The inert gas supply apparatus 3 and the dehumidifying apparatus 4 are disposed outside of the brazing furnace 1. The inert gas supply apparatus 3 is connected to the dehumidifying apparatus 4 via a gas line 31, and the dehumidifying apparatus 4 is connected to the brazing chamber 2 via a gas line 41.

The brazing chamber 2 of the present example includes the heating apparatuses 21, a graphite muffle 22 that is disposed inward of the heating apparatuses 21, and an endless-drive, belt-type transport apparatus 23, which transports the object to be processed 100. In the state in which the front door 11 is closed, the transport apparatus 23 is completely housed inside the brazing chamber 2 and is separated from a transport apparatus (not shown) provided outside the brazing chamber 2. Consequently, it is possible to prevent moisture, oil, and the like, which are adhered to the transport apparatus provided outside of the brazing chamber 2, from being brought into the furnace. The dimensions of the soaking region of the brazing chamber 2 are: a length of 300 mm, a width of 200 mm, and a height of 200 mm.

The inert gas supply apparatus 3 of the present example is configured to generate nitrogen gas by vaporizing liquid nitrogen. The dew point of the nitrogen gas generated from the inert gas supply apparatus 3 is typically from −74° C. to −78° C., and the oxygen concentration is typically from 0.1 ppm to 0.5 ppm. The nitrogen gas generated from the inert gas supply apparatus 3 is supplied through the gas line 31 to the dehumidifying apparatus 4.

The dehumidifying apparatus 4 of the present example is connected to the gas line 31, and includes a flow path switch 42, two gas flow paths 43 connected to the flow path switch 42 in parallel to each other, moisture absorbents 44 respectively disposed in the gas flow paths 43, and a regenerating device 45. The flow path switch 42 can switch the supply and stoppage of the inert gas to each gas flow path. The moisture absorbents 44 contact nitrogen gas and can absorb moisture in the nitrogen gas. The regenerating device 45 can remove moisture, which has absorbed into the moisture absorbents 44, from the moisture absorbents 44.

The flow path switch 42 of the present example includes a branch portion 421 to distribute nitrogen gas that is supplied from the inert gas supply apparatus 3 to each gas flow path 43, and switching valves 422 that are provided between the branch portion 421 and each moisture absorbent 44. The switching valves 422 can switch the supply and stoppage of the nitrogen gas to the moisture absorbents 44 respectively by switching open and closed. In addition, each switching valve 422 can control the flow amount of the nitrogen gas into each moisture absorbent 44 by adjusting its degree of opening.

The two gas flow paths 43 are connected to the branch portion 421 in parallel with each other. Each gas flow path 43 has the moisture absorbent 44 disposed therein. The moisture absorbents 44 of the present example are, specifically, adsorption towers packed with zeolite. The dew point of the nitrogen gas that has passed through the moisture absorbents 44 is −80° C. or less.

The regenerating device 45 of the present example include heaters 451 that heat each moisture absorbent 44 and a regenerating pump 452 that degasses the moisture absorbents 44. The regenerating pump 452 is connected to the gas flow paths 43 via three-way valves 453 that are provided at each inlet and outlet of each moisture absorbent 44. In addition, between the regenerating pump 452 and the three-way valves 453, a shut-off valve 454 is provided to shut off the regenerating pump 452 from the three-way valves 453. It is noted that in the present example, although the heaters 451 have been used to heat the moisture absorbents 44, the moisture absorbents 44 can be heated using other heating devices such as a microwave heating device or the like instead of the heater 451.

When regeneration of a moisture absorbent 44 will be performed, the switching valve 422 connected to that moisture absorbent 44 is first closed, and a closed flow path, which includes the moisture absorbent 44, two of the three-way valves 453 and the regenerating pump 452, is formed. Then, the moisture absorbent 44 is degassed by the regenerating pump 452 while being heated by a heater 451. Moisture, which is absorbed in the heated moisture absorbent 44, is desorbed therefrom. The moisture absorbent 44 is regenerated by removing this moisture using the regenerating pump 452, and the dehumidification capability can be restored.

The nitrogen gas that has passed through a moisture absorbent 44 and has a dew point of −80° C. or less is supplied to the brazing chamber 2 via the gas line 41. The dew point of the nitrogen gas is typically from −80° C. to −84° C., and the oxygen concentration is typically from 0.1 ppm to 0.5 ppm.

The brazing furnace 1 of the present example is configured such that dehumidified nitrogen gas can be supplied to the brazing chamber 2 continuously at 5 m³/h to thereby replace the interior of the brazing chamber 2 with the nitrogen gas. After the brazing chamber 2 is filled with the nitrogen gas, excess nitrogen gas is discharged from a gas-escape port (not shown) provided in the vicinity of the front door 11.

Next, the operation and effects of the brazing furnace 1 of the present example will be described. The brazing furnace 1 includes the dehumidifying apparatus 4 that dehumidifies the nitrogen gas supplied from the inert gas supply apparatus 3, and is configured to supply the dehumidified nitrogen gas into the brazing chamber 2. In this way, the nitrogen gas generated from the inert gas supply apparatus 3 is not supplied directly into the brazing chamber 2, but rather is supplied into the brazing chamber 2 after dehumidification has been performed, so that the total amount of the moisture brought into the brazing chamber 2 from the outside and the moisture originally contained in the nitrogen gas can be reduced more than in the past. Consequently, degradation of brazeability can be curtailed in brazing with a reduced applied-amount of flux or in brazing without using flux, and satisfactory brazing joints can be formed.

In addition, according to the brazing furnace 1, it is possible to mitigate the effects on brazeability owing to the atmosphere outside the brazing furnace 1, the storage environment of the object to be processed 100 and the like. Therefore, by using the brazing furnace 1, it is possible to reduce the amount of moisture brought into the brazing chamber 2 to thereby form a satisfactory brazing joint even in, for example, high-temperature, high-humidity regions and seasons, or even in cases in which strict control of the storage environment of the object to be processed 100 is difficult.

In addition, the inert gas supply apparatus 3 is configured to generate high-purity nitrogen gas by vaporizing liquid nitrogen. Accordingly, the number of dehumidification instances can be reduced and the dehumidifying apparatus 4 can be simplified.

The dehumidifying apparatus 4 includes the moisture absorbents 44 that contact the nitrogen gas and absorb moisture in the nitrogen gas. Accordingly, it is possible to further decrease the dew point of the high-purity nitrogen gas generated from the inert gas supply apparatus 3 to thereby easily achieve an extremely low dew point of −80° C. or less. Consequently, degradation of brazeability can be curtailed more effectively in brazing with a reduced applied-amount of flux, or in brazing without applying flux.

The dehumidifying apparatus 4 further includes the two gas flow paths 43 connected in parallel to each other, the moisture absorbents 44 that are respectively disposed in the gas flow paths 43, and the flow path switch 42 that switches the supply and stoppage of the nitrogen gas to each gas flow path 43. Consequently, when the dehumidification capability of either one of the moisture absorbents 44 decreases, supply of the nitrogen gas to that moisture absorbent 44 can be stopped, and the nitrogen gas can be continuously supplied to the other moisture absorbent 44. Thereby, the moisture absorbent 44, in which the dehumidification capability has decreased, can be replaced or regenerated while dehumidification of the nitrogen gas continues. As a result, the maintainability of the brazing furnace 1 can be further improved.

The dehumidifying apparatus 4 further includes the regenerating device 45 that removes moisture, which has absorbed in the moisture absorbents 44, from the moisture absorbents 44. Thereby, the frequency of replacement of the moisture absorbents 44 can be reduced and the running cost of the brazing furnace 1 can be reduced.

### Working Example 2

The present example is an example of a two-chambered brazing furnace 102 equipped with the brazing chamber 2 and a preheating chamber 5 connected to the brazing chamber 2. It is noted that, of the symbols used in the present example and thereafter, symbols that are identical to symbols used in the previous example indicate structural elements and the like that are the same as in the previous example, except as otherwise explained.

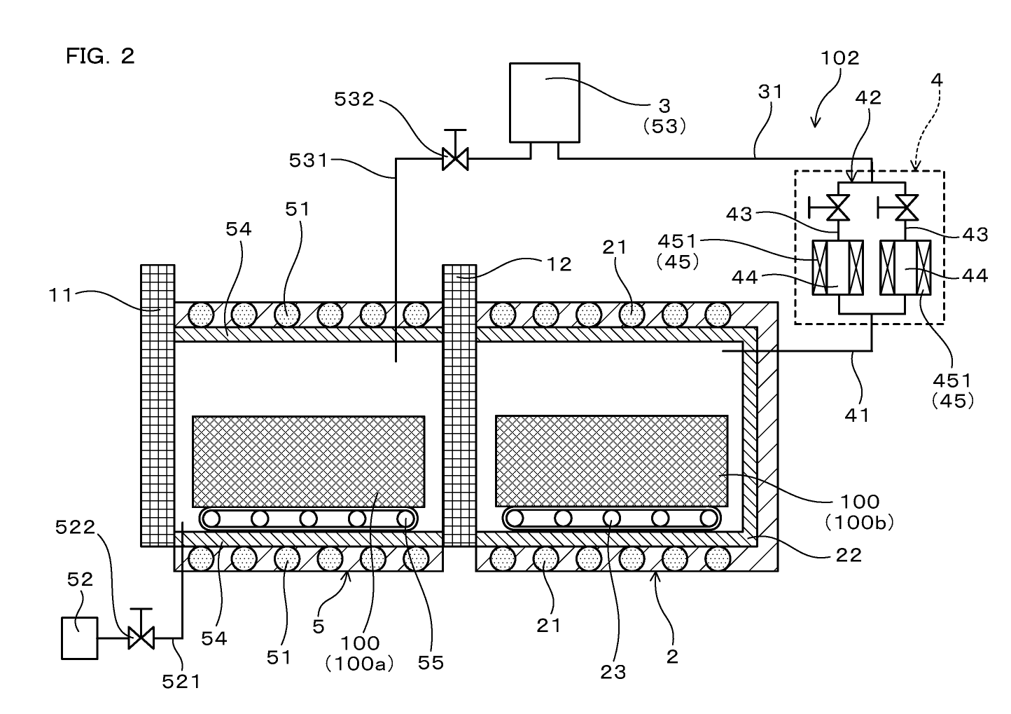

As shown in FIG. 2, the brazing furnace 102 of the present example includes the brazing chamber 2, the preheating chamber 5 connected to the brazing chamber 2 and equipped with the preheating devices 51 that preheats the object to be processed 100 to a temperature lower than the brazing temperature, a preheating pump 52 that depressurizes the interior of the preheating chamber 5, and a pressure-restoring gas supply apparatus 53 that supplies an inert gas for re-pressurizing the interior of the preheating chamber 5 after the pressure reduction.

The brazing furnace 102 is configured such that the object to be processed 100 can be placed inside thereof through the entrance/exit provided in the preheating chamber 5, and can be taken out of the furnace. The front door 11, which is capable of opening and closing, is provided at the entrance/exit of the preheating chamber 5. In addition, the preheating chamber 5 is connected to the brazing chamber 2, and an intermediate door 12, which is capable of opening and closing, is provided between the preheating chamber 5 and the brazing chamber 2.

The preheating pump 52 is arranged outside the brazing furnace 102, and is connected to the preheating chamber 5 via an exhaust line 521. An exhaust valve 522, which functions as a cutoff between the preheating pump 52 and the preheating chamber 5, is provided in the exhaust line 521. It is noted that the preheating pump 52 is an oil-sealed rotary pump with a mechanical booster pump.

In the present example, the inert gas supply apparatus 3 is used also as the pressure-restoring gas supply apparatus 53. Specifically, the inert gas supply apparatus 3 is connected also to the preheating chamber 5 via a pressure-restoration gas line 531. Thereby, nitrogen gas formed by vaporizing liquid nitrogen is supplied to the preheating chamber 5. In addition, a pressure-restoration valve 532, which functions as a cutoff between the inert gas supply apparatus 3 and the preheating chamber 5, is provided in the pressure-restoration gas line 531.

The inert gas supply apparatus 3 is configured such that nitrogen gas can be continuously supplied to the preheating chamber 5 at 5 m³/h. It is noted that surplus nitrogen gas, which has been supplied into the preheating chamber 5, is discharged from a gas-escape port (not shown) provided in the vicinity of the front door 11.

The preheating chamber 5 includes the preheating devices 51, stainless-steel muffles 54 disposed inward of the preheating devices 51, and an endless-drive, belt-type transport apparatus 55 which transports the object to be processed 100. The dimensions of the soaking region of the preheating chamber 5 are: a length of 300 mm, a width of 200 mm, and a height of 200 mm.

The preheating chamber 5 is configured such that, by operating the preheating vacuum pump 52 with the front door 11 and the intermediate door 12 being closed, the pressure in the chamber can be set to 0.4 Pa or less. It is noted that the pressure inside the chamber can be measured by a Pirani gauge (not shown). Other aspects are the same as in working example 1. It is noted that the dehumidifying apparatus 4 of the present example includes the regenerating pump 452, the three-way valves 453, and the shut-off valve 454, but these are not described in FIG. 2 for sake of simplicity.

The brazing furnace 102 of the present example can be used, for example, as described below. First, the front door 11 is opened and the object to be processed 100, which is composed of an aluminum material, is placed in the preheating chamber 5. Subsequently, the front door 11 and the intermediate door 12 are closed. In this state, the preheating pump 52 is operated to exhaust the interior of the preheating chamber 5, and the preheating devices 51 are simultaneously operated to preheat the object to be processed 100 (100a). The timing at which the exhaust is started and the timing at which the preheating of the object to be processed 100 is started may be simultaneous, or one may start earlier than the other. From the viewpoint of avoiding unnecessary oxidation of the object to be processed 100, it is preferable to start the exhaust prior to the start of preheating.

The attained temperature in the preheating may be set to, for example, 200° C. or higher. At the point in time when the pressure inside the preheating chamber 5 reaches 100 Pa or less and the temperature of the object to be processed 100 reaches the intended temperature, preheating is complete. After the preheating is complete, the exhaust valve 522 is closed; subsequently, the preheating pump 52 and the preheating devices 51 are stopped. Thereafter, the pressure-restoration valve 532 is opened and the pressure inside the preheating chamber 5 is restored using nitrogen gas until it reaches atmospheric pressure. Thereby, the surroundings of the object to be processed 100a become an inert gas atmosphere.

After the pressure restoration is complete, the pressure-restoration valve 532 is closed and, subsequently, the intermediate door 12 is opened. Thereafter, the object to be processed 100 is transported into the brazing chamber 2 and the intermediate door 12 is closed. Because dehumidified nitrogen gas is continuously supplied to the interior of the brazing chamber 2, an inert gas atmosphere of the surroundings of the object to be processed 100 is maintained during the transport of the object to be processed 100.

Thereafter, the object to be processed 100 (100b) disposed inside the brazing chamber 2 is heated by the heating apparatuses 21, and thereby brazing is performed. After the brazing is complete, the intermediate door 12 is opened and the object to be processed 100 is transported into the preheating chamber 5. Because a nitrogen gas atmosphere is maintained in the interior of the preheating chamber 5, the object to be processed 100, for which brazing has ended, can be cooled in the nitrogen gas atmosphere. After the cooling, the front door 11 is opened, and the object to be processed 100 is taken out of the furnace. Brazing of the material to be processed 100 can be performed by the above.

The brazing furnace 102 of the present example is configured such that preheating can be performed in a reduced-pressure atmosphere, pressure restoration can be performed by supplying nitrogen gas, and brazing can be performed in a dehumidified nitrogen gas atmosphere. Therefore, when performing brazing with a reduced applied-amount of flux or when performing brazing without using flux, it is possible to mitigate the effects on brazeability owing to the storage environment and the usage conditions of the object to be processed 100, the jig, and the filler material, the fluctuations in the environment outside the furnace and the like. As a result, it is possible to curtail degradation of brazeability more effectively to thereby form satisfactory brazing joints stably.

In addition, with regard to the brazing furnace 102, because it is possible to mitigate the effects on brazeability owing to the storage environment of the object to be processed 100 or the like, the brazing furnace 1 can be suitably used even in, for example, high-temperature, high-humidity regions, seasons, and the like. In addition, the brazing furnace 102 can form satisfactory brazing joints even in work environments in which strict control of the storage environment or the like of the object to be processed 100 and the jig is difficult. As for the rest, the brazing furnace 102 of the present example can provide the same operations and effects as in working example 1.

### Working Example 3

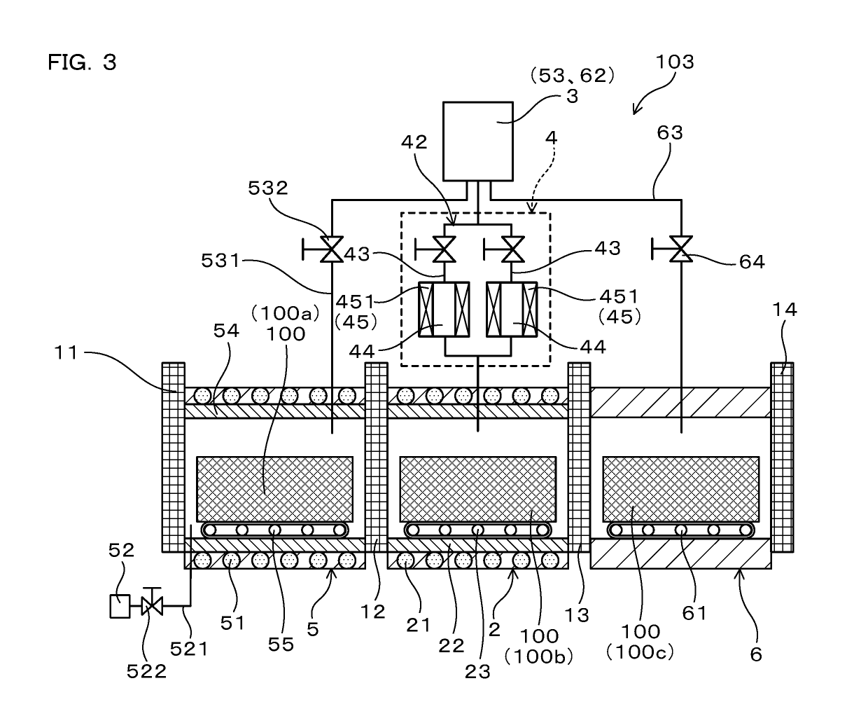

The present example is an example of a three-chamber type brazing furnace 103 equipped with the preheating chamber 5, the brazing chamber 2, and a cooling chamber 6. As shown in FIG. 3, with regard to the brazing furnace 103 of the present example, the preheating chamber 5, the brazing chamber 2, and the cooling chamber 6 are arranged in this order. An entrance to place the object to be processed 100 inside the furnace is provided in the preheating chamber 5. The front door 11, which is capable of opening and closing, is provided at the entrance. The intermediate door 12, which is capable of opening and closing, is provided between the preheating chamber 5 and the brazing chamber 2, and a rear door 13, which is capable of opening and closing, is provided between the brazing chamber 2 and the cooling chamber 6.

The cooling chamber 6 includes an endless-drive, belt-type transport apparatus 61, which transports the material to be processed 100. An exit to take out the object to be processed 100 outside the furnace is provided in the cooling chamber 6. An exit door 14, which is capable of opening and closing, is provided at the exit to impede the atmosphere from flowing into the brazing furnace 103 from the outside. It is noted that a metal curtain or the like may be installed instead of the exit door 14.

In addition, a cooling gas supply apparatus 62, which is disposed outside of the furnace, is connected to the cooling chamber 6 via a cooling gas line 63. In the present example, the inert gas supply apparatus 3 is also used as the cooling gas supply apparatus 62. Specifically, the inert gas supply apparatus 3 is also connected to the cooling chamber 6 via the cooling gas line 63. A cooling gas valve 64, which functions as a cutoff between the inert gas supply apparatus 3 and the cooling chamber 6, is provided in the cooling gas line 63.

The inert gas supply apparatus 3 is configured such that nitrogen gas can be continuously supplied into the cooling chamber 6 at 5 m³/h. It is noted that surplus nitrogen gas is discharged via a gas-escape port (not shown) provided in the vicinity of the exit door 14.

The brazing furnace 103 of the present example is configured such that the object to be processed 100 can be placed in the furnace via an entrance provided in the preheating chamber 5. The object to be processed 100 (100a) disposed inside the preheating chamber 5 is preheated, and then transported into the brazing chamber 2. The object to be processed 100 (100b), for which brazing has been completed in the brazing chamber 2, is transported into the cooling chamber 6. The object to be processed 100 (100c), which has been cooled in the nitrogen gas atmosphere in the cooling chamber 6, is taken out of the furnace from the exit of the cooling chamber 6. Other aspects are the same as in working example 2. It is noted that the dehumidifying apparatus 4 of the present example includes the regenerating pump 452, the three-way valves 453, and the shut-off valve 454 in the same way as in working example 1, but these are not described in FIG. 3 for sake of simplicity.

Thus, the brazing furnace 103 further includes the cooling chamber 6 that is connected to the brazing furnace 103, and the cooling gas supply apparatus 62 that supplies nitrogen gas into the cooling chamber 6. With regard to the brazing furnace 103, as mentioned above, unnecessary oxidation of the object to be processed 100 can be curtailed by cooling the object to be processed 100 in a nitrogen gas atmosphere inside the cooling chamber 6. In addition, because the cooling chamber 6 is filled with nitrogen gas, it is possible to impede the atmosphere from flowing into the brazing chamber 2 from the cooling chamber 6. As for the rest, the brazing furnace 103 of the present example can provide the same operations and effects as in working example 2.

In case the brazing furnace 103 includes the cooling chamber 6 as in the present example, the cooling chamber 6 may be further configured such that the chamber interior can be exhausted and the pressure inside the chamber can be restored. In this case, by exhausting the chamber interior of the cooling chamber 6 and subsequently restoring the pressure using nitrogen gas, the atmosphere can be reliably prevented from flowing into the interior of the cooling chamber 6. As a configuration capable of achieving such functions, a configuration is conceivable in which, for example, the exhaust line of the preheating pump is connected to the cooling chamber 6, in the same way as in the preheating chamber 5.

Further, in the present example, although the inert gas supply apparatus 3 is also used as the pressure-restoring gas supply apparatus 53 and the cooling gas supply apparatus 62, gas-supply apparatuses may be separately provided as the pressure-restoring gas supply apparatus 53 and the cooling gas supply apparatus 62, respectively.

### Experimental Example 1

The present example is an example in which brazing was performed by variously changing the dew point of the inert gas to be supplied into the brazing chamber 2. In the present example, two kinds of aluminum materials (test materials A1 and A2) having the chemical components and the layered structures as shown in Table 1 were prepared. These test materials are single-sided brazing sheets having a thickness of 0.6 mm, in which a filler material is clad bonded onto one surface of a core.

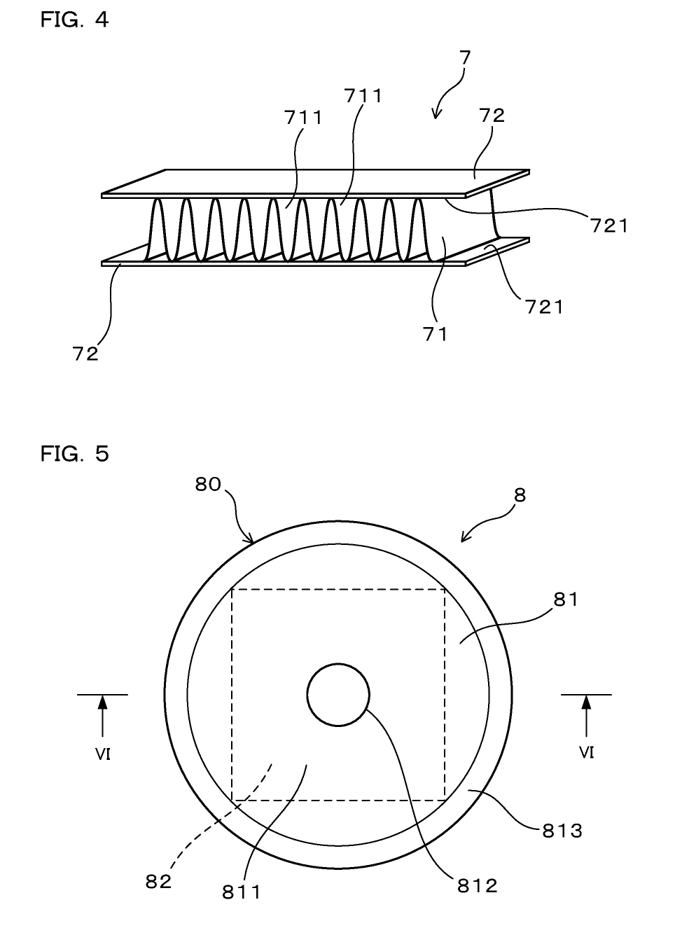

In the present example, an outer fin test specimen 7, which simulated a junction between outer fins and a refrigerant flow path, was prepared and brazed. The test specimen 7 of the present example, as shown in FIG. 4, includes a corrugated fin 71 and two flat sheets 72 that sandwich the corrugated fin 71. The corrugated fin 71 is made of JIS A3003 alloy. The flat sheets 72 are made of the test material, and the filler materials 721 of the flat sheets 72 are in contact with apex portions 711 of the corrugated fin 71. The length of the corrugated fin 71 is 50 mm. The length of each flat sheets 72 is 60 mm, the width is 25 mm, and the distance between the flat sheets is 10 mm.

The test specimens 7 were assembled specifically in the following way. First, after a sheet material of A3003 alloy was cut into the prescribed dimensions, it was corrugated to form the corrugated fin 71. Further, separately from the preparation of the corrugated fin 71, the test material was cut into the above-mentioned dimensions to prepare the flat sheets 72. Then, these components were degreased using acetone.

Here, for the flat sheets 72 using the test material A1 (Table 2, Experiment No. 3), a fluoride-based flux was applied onto the filler material 721 in the applied amount shown in Table 2. The applied amount of flux was calculated in the following way. After the mass (g) of the flat sheets 72 was measured in advance prior to the application of flux, the flux was applied onto the flat sheets and then was dried. The total amount of flux applied was calculated by subtracting the mass (g) of the flat sheets 72, which was measured prior to the application of flux, from the mass (g) of the flat sheets 72 after the drying of the flux. The applied amount of flux (g/cm²) was calculated by dividing the total amount (g) by the applied area of flux (cm²), i.e. the area of the filler material 721.

Thereafter, the corrugated fin 71 and the flat sheet 72 were mounted on the flat sheet 72 in this order so as to assemble the test specimen 7 as shown in FIG. 4. This test specimen 7 was held by a jig, which is not illustrated, in the layered direction, and thereby fixed.

After the test specimen 7 was fixed to the jig, preheating and brazing-heating were sequentially performed using the brazing furnace 102 shown in working example 2 (see FIG. 2) to braze the test specimen 7. As shown in Table 2, in Experiment Nos. 1, 3, and 4, the test specimen 7 was disposed inside the preheating chamber 5, and preheating was performed in a nitrogen gas atmosphere at normal pressure under the condition of heating the test specimen to 200° C. In Experiment No. 2, the test specimen 7 was disposed inside the preheating chamber 5, and preheating was performed in a reduced-pressure atmosphere of 10 Pa under the condition of heating the test specimen to 300° C.

After the preheating was performed under the above-mentioned conditions, the test specimen 7 was transported into the brazing chamber 2, and brazing-heating was performed by heating to 600° C. at a temperature increase rate of about 13° C./min. At this time, as shown in Table 2, in Experiment Nos. 1 and 2, dehumidified nitrogen gas, which had been dehumidified using the dehumidifying apparatus 4 so that the dew point became −80° C. or less, was supplied to the interior of the brazing furnace 1. In Experiment No. 3, after the dew point of the nitrogen gas generated from the inert gas supply apparatus 3 was adjusted to −55° C., the nitrogen gas was supplied to the brazing chamber 2 without performing dehumidification. In Experiment No. 4, nitrogen gas generated from the inert gas supply apparatus 3 was supplied to the brazing chamber 2 without performing dehumidification. The dew points of the nitrogen gas before and after dehumidification and the dew point in the brazing chamber 2 at the time of brazing-heating in each experiment were as shown in Table 2.

After the brazing was completed, the test specimen 7 was transported into the preheating chamber 5 and cooled to 450° C. in the preheating chamber 5. Thereafter, the test specimen 7 was taken out of the furnace.

After brazing, the corrugated fin 71 was removed from the test specimen 7, and the joining percentage was calculated based on the traces of the fillets present on the flat sheets 72 in the following way. First, for the trace of each fillet, the length in the width direction of the flat sheet 72 was measured and the total of the lengths was calculated. Separately from this calculation, based on the assumption that the flat sheet 72 and the corrugated fin 71 were completely joined, the total of the lengths of the fillets in the sheet width direction was calculated. Then, the ratio of the former value to the latter value was defined as the joining percentage (%). It is noted that the latter value can be calculated by, for example, multiplying the width of the corrugated fin 71 and the number of the tops 711 (see FIG. 4), that is, the number of portions to be joined to the flat sheets 72.

In the columns of “Evaluation Results”, the symbol “A” was recorded when the joining percentage was 95% or more, the symbol “B” was recorded when the joining percentage was 85% or more and less than 95%, the symbol “C” was recorded when the joining percentage was 60% or more and less than 85%, and the symbol “D” was recorded when the joining percentage was less than 60%. In the evaluation of the brazeability using the outer fin test specimen 7, in the case of the symbols A and B in which the joining percentage is 85% or more, the brazeability was judged to be acceptable because of satisfactory brazeability. In the case of the symbols C and D in which the joining percentage is less than 85%, the brazeability was judged to be unacceptable because of the risk of brazing failures.

TABLE 1
Table 1

| | | | | | | | | | Total | |
|---|---|---|---|---|---|---|---|---|---|---|
| Test | | | | | | | | Clad | Sheet | |
| Material | Layered | Chemical Composition (mass %) | | | | | | Ratio | Thickness | |
| Symbol | Structure | Si | Fe | Cu | Mn | Mg | Bi | (%) | (mm) | Remarks |
| A1 | Filler | 10 | — | — | — | — | — | 10 | 0.6 | Flux |
| | material | | | | | | | | | brazing |
| | Core | 0.27 | 0.6 | 0.15 | 1.2 | — | — | — | | |
| | material | | | | | | | | | |
| A2 | Filler | 10 | — | — | — | — | 0.02 | 10 | 0.6 | Fluxless |
| | material | | | | | | | | | brazing |
| | Core | 0.35 | — | 0.27 | — | 0.6 | — | — | | |
| | material | | | | | | | | | |

TABLE 2
Table 2

| | | | | | | | | Brazing-heating | | |
|---|---|---|---|---|---|---|---|---|---|---|
| | | | Preheating | | | Dew point of | | Conditions | | |
| | | Applied | Conditions | | | Inert gas (° C.) | | Dew point | | |
| | Test | Amount | | Highest | | Before | After | during | Highest | |
| Test | Material | of Flux | | Temperature | Dehumidi- | Dehumidi- | Dehumidi- | Heating | Temperature | Evaluation |
| No. | Symbol | (g/m²) | Pressure | (° C.) | fication | fication | fication | (° C.) | (° C.) | Results |
| 1 | A2 | None | Normal | 200 | Done | −76 | −82 | −68 | 600 | B |
| | | | Pressure | | | | | | | |
| 2 | A2 | None | 10 Pa | 300 | Done | −74 | −80 | −80 | 600 | A |
| 3 | A1 | 1 | Normal | 200 | Not done | −55 | −55 | −45 | 600 | D |
| | | | Pressure | | | | | | | |
| 4 | A2 | None | Normal | 200 | Not done | −76 | −76 | −63 | 600 | C |
| | | | Pressure | | | | | | | |

As shown in Table 2, in Experiment Nos. 1 and 2, because dehumidification of the nitrogen gas generated from the inert gas supply apparatus 3 was performed, it was possible to set the dew point of the nitrogen gas to be supplied into the brazing chamber 2 to −80° C. or less. Thereby, it was possible to achieve a joinability of 85% or more.

On the other hand, in Experiment Nos. 3 and 4, because dehumidification of the nitrogen gas generated from the inert gas supply apparatus 3 was not performed, it was not possible to set the dew point of the nitrogen gas to be supplied into the brazing chamber 2 to −80° C. or less. As a result, brazeability was degraded as shown in Table 2. In particular, as shown in Experiment No. 4, even when nitrogen gas formed by vaporizing liquid nitrogen was supplied as is, it was not possible to form satisfactory brazing joints.

### Experimental Example 2

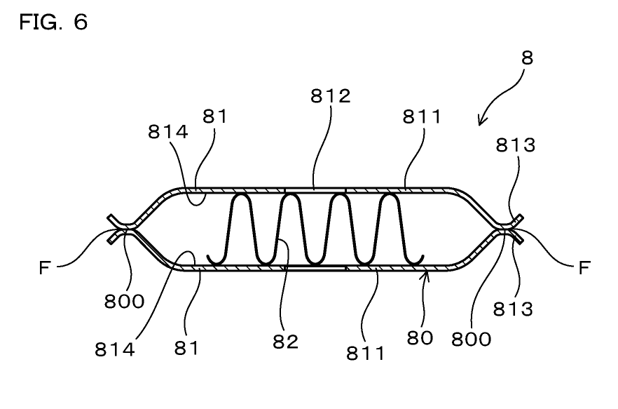

In the present example, a cup test specimen 8 that is shown in FIGS. 5 and 6 was used to evaluate brazeability in the case in which the dew point of the nitrogen gas to be supplied to the brazing chamber 2 was variously changed. In the present example, two kinds of aluminum materials (test materials B1 and B2) which have the chemical components and layered structures as shown in Table 3 were prepared. These test materials are single-sided brazing sheets having a thickness of 0.4 mm, in which a filler material is clad bonded onto one surface of a core material.

The cup test specimen 8 (see FIGS. 5 and 6) that was used for evaluation of brazezbility in the present example was prepared in the following way. First, press working was performed on a sheet material sampled from the test material to prepare the circular cups 81 shown in FIGS. 5 and 6. The diameter of the cups 81 was 30 mm, and a vent 812 having a diameter of 5 mm was formed at the center of the bottom 811 of each cup 81. A flange 813 was formed on the outer circumferential edge portion of each cup 81. Further, as shown in FIG. 6, the cups 81 were formed so that the filler material 814 was on the inside thereof. Thereafter, the cups 81 and a corrugated fin 82 were degreased.

Here, top sheets using the test material B1 (Table 4, Experiment Nos. 11, 14 and 15) had a fluoride-based flux applied on the filler material 814 in the applied amounts shown in Table 4 in the same way as in experimental example 1.

The two cups 81 and the corrugated fin 82 prepared in the above-mentioned way were combined to assemble the test specimen 8 shown in FIGS. 5 and 6. The test specimen 8 includes a hollow member 80 composed of the two cups 81 and the corrugated fin 82 disposed inside the hollow member 80. The hollow member 80 includes abutting portions 800 at which the flanges 813 of the cups 81 abut with each other. The corrugated fin 82 is in contact with the brazing material 814 on the bottom 811 of each cup 81.

After holding and fixing the test specimen 8 in the stacked direction using a jig that is not illustrated, the test specimen 8 was brazed in the same manner as in experimental example 1. In the present example, dehumidification of the nitrogen gas generated from the inert gas supply apparatus 3 was performed in Experiment Nos. 11 to 13. In addition, dehumidification of the nitrogen gas generated from the inert gas supply apparatus 3 was not performed and was supplied into the brazing furnace 102 as is in Experiment Nos. 14 to 17. The conditions for preheating, the dew points of nitrogen gas before and after dehumidification, and the dew points inside the brazing chamber 2 during brazing-heating were as shown in Table 4.

The test specimen 8 after brazing was visually observed to evaluate the appearance of a fillet F (see FIG. 6) that had been formed outside the abutting portion 800. In the columns of “Evaluation Results”, the symbol “A” was recorded in the case in which the fillet had a uniform shape. In the cases in which a continuous fillet was formed although it was partially non-uniform, the symbol “B” was recorded.

In the cases in which the fillet is non-uniform overall, or a stitch occurred in a portion of the fillet, the symbol “C” was recorded. In the case in which a stitch was present throughout the fillet, or in the case in which no fillet was formed, the symbol “D” was recorded. Here, “stitch” mentioned above refers to a state in which the fillet is formed intermittently; in other words, the fillet is discontinuous owing to pinhole-shaped defects, or the like, and looks like a seam. A stitch does not always cause leakage of the contents in the hollow member 80; however, in many cases, it is considered to be defective as impairing the joining quality of the products, as with the case in which no fillet is formed.

In the evaluation of the fillet shape, the cases of the symbols A and B in which continuous fillets were formed, were judged to be acceptable because of satisfactory brazeability. On the other hand, the cases of the symbols C and D in which a stitch occurred, or in which no fillet was formed, were judged to be unacceptable because of the risk of brazing failures.

TABLE 3
Table 3

| | | | | | | | | | Total | |
|---|---|---|---|---|---|---|---|---|---|---|
| Test | | | | | | | | Clad | Sheet | |
| Material | Layered | Chemical Composition (mass %) | | | | | | Ratio | Thickness | |
| Symbol | Structure | Si | Fe | Cu | Mn | Mg | Bi | (%) | (mm) | Remarks |
| B1 | Filler | 10 | — | — | — | — | — | 10 | 0.4 | Flux |
| | material | | | | | | | | | brazing |
| | Core | 0.27 | 0.6 | 0.15 | 1.2 | — | — | — | | |
| | material | | | | | | | | | |
| B2 | Filler | 10 | — | — | — | — | 0.02 | 10 | 0.4 | Fluxless |
| | material | | | | | | | | | brazing |
| | Core | 0.35 | — | 0.27 | — | 0.6 | — | — | | |
| | material | | | | | | | | | |

TABLE 4
Table 4

| | | | | | | | | | Brazing-heating | | |
|---|---|---|---|---|---|---|---|---|---|---|---|
| | | | Preheating | | | | Dew point of | | Conditions | | |
| | | Applied | Conditions | | | | Inert gas (° C.) | | Dew point | | |
| | Test | amount | | | Highest | | Before | After | during | Highest | |
| Test | Material | of Flux | | | Temperature | Dehumidi- | Dehumidi- | Dehumidi- | Heating | Temperature | Evaluation |
| No. | Symbol | (g/m²) | Pressure | | (° C.) | fication | fication | fication | (° C.) | (° C.) | Results |
| 11 | B1 | 1 | 10 | Pa | 300 | Done | −74 | −80 | −80 | 600 | B |
| 12 | B2 | None | 100 | Pa | 200 | Done | −76 | −82 | −81 | 600 | B |
| 13 | B2 | None | 10 | Pa | 300 | Done | −76 | −82 | −82 | 600 | A |
| 14 | B1 | 1 | Normal | | 200 | Not done | −76 | −76 | −62 | 600 | C |
| | | | Pressure | | | | | | | | |
| 15 | B1 | 1 | 10 | Pa | 300 | Not done | −74 | −74 | −74 | 600 | C |
| 16 | B2 | None | Normal | | 200 | Not done | −76 | −76 | −62 | 600 | D |
| | | | Pressure | | | | | | | | |
| 17 | B2 | None | 100 | Pa | 200 | Not done | −76 | −76 | −75 | 600 | C |

As shown in Table 4, dehumidification of the nitrogen gas generated from the inert gas supply apparatus 3 was performed in Experiment Nos. 11 to 13, and thus it was possible to set the dew point of the nitrogen gas to be supplied into the brazing chamber 2 to −80° C. or less. Thereby, it was possible to form a continuous fillet.

On the other hand, in Experiment Nos. 14 to 17, dehumidification of the nitrogen gas generated from the inert gas supply apparatus 3 was not performed, and thus it was not possible to set the dew point of the nitrogen gas to be supplied into the brazing chamber 2 to −80° C. or less. As a result, degradation of the brazeability was caused as shown in Table 4.

As shown in Tables 2 and 4, by supplying the dehumidified inert gas into the brazing chamber 2, satisfactory brazing joints could be formed in brazing with a reduced amount of flux or in brazing without using flux. Further, satisfactory brazing joints could be formed both in the outer fin test specimen 7 and in the cup test specimen 8 by either brazing.

As a result, it was understood that degradation of brazeability can be effectively curtailed by performing dehumidification of the inert gas generated from the inert gas supply apparatus 3. In addition, it was understood that, because it is possible to mitigate the effects on brazeability owing to the atmosphere outside of the brazing furnaces 1, 102 and 103 and the storage environment of the object to be processed 100 or the like, the amount of moisture brought into the brazing chamber 2 can be reduced to thereby form a satisfactory brazing joint even in, for example, high-temperature, high-humidity regions and seasons, or even in cases in which strict control of the storage environment of the object to be processed 100 is difficult.

It is noted that aspects of the brazing furnace and the brazing method according to the present invention are not limited to the aspects of the above-mentioned embodiments and experimental examples and the configurations of which can be modified within a range that does not deviate from the gist of the present invention.

1. A brazing furnace used in brazing of an object to be processed composed of an aluminum material, comprising:
a brazing chamber equipped with a heating apparatus that heats the object to be processed to a brazing temperature;
an inert gas supply apparatus that supplies an inert gas into the brazing chamber; and
a dehumidifying apparatus that is interposed between the inert gas supply apparatus and the brazing chamber, and performs dehumidification of the inert gas.

2. The brazing furnace according to claim 1, wherein the dehumidifying apparatus includes a moisture absorbent that absorbs moisture in the inert gas by contacting with the inert gas.

3. The brazing furnace according to claim 2, wherein the dehumidifying apparatus further includes:
first and second gas flow paths connected in parallel with each other,
first and second moisture absorbents that absorb moisture in the inert gas by contacting the inert gas and that are respectively arranged in the first and second gas flow paths, and
a flow path switch configured to selectively supply the inert gas from the inert gas supply apparatus to either the first gas flow path or the second gas flow path.

4. The brazing furnace according to claim 2, wherein the dehumidifying apparatus further includes a regenerating device that removes moisture, which has absorbed in the moisture absorbent, from the moisture absorbent.

5. The brazing furnace according to claim 1, further comprising:
a preheating chamber connected to the brazing chamber and equipped with a preheating device that preheats the object to be processed to a temperature lower than the brazing temperature,
a preheating pump that depressurizes the interior of the preheating chamber, and
a pressure-restoring gas supply apparatus that supplies an inert gas for repressurizing the interior of the preheating chamber after the pressure reduction.

6. The brazing furnace according to claim 5, wherein the brazing furnace and the preheating pump are configured to depressurize the interior of the preheating chamber to 100 Pa or less.

7. The brazing furnace according to claim 5, wherein the preheating chamber and the preheating device are configured to heat the object to be processed to greater than 200° C.

8. The brazing furnace according to claim 1, further comprising a cooling chamber connected to the brazing chamber and a cooling gas supply apparatus that supplies an inert gas into the cooling chamber.

9. A method for brazing an aluminum material in which an object to be processed composed of an aluminum material is brazed in an inert gas atmosphere, the method comprising:
dehumidifying an inert gas;
making the surroundings of the object to be processed an inert gas atmosphere by supplying the dehumidified inert gas; and
heating the object to be processed to a brazing temperature in the inert gas atmosphere and brazing the object.

10. The method for brazing an aluminum material according to claim 9, wherein in the dehumidification, moisture in the inert gas atmosphere is removed by contacting the inert gas with a moisture absorbent that absorbs moisture.

11. The method for brazing an aluminum material according to claim 9, wherein in the dehumidification, moisture in the inert gas atmosphere is removed so that the dew point of the inert gas is −80° C. or less.

12. The method for brazing an aluminum material according to claim 9, further comprising preheating the object to be processed to a temperature lower than the brazing temperature in a reduced-pressure atmosphere of 100 Pa or less prior to the brazing.

13. The method for brazing an aluminum material according to claim 9, further comprising applying a fluoride-based flux to a to-be-brazed portion of the object to be processed prior to the brazing.

14. The method for brazing an aluminum material according to claim 13, wherein an applied amount of the fluoride-based flux is 2 g/m² or less.

15. The method for brazing an aluminum material according to claim 9, wherein no flux is applied to a to-be-brazed portion of the object to be processed.

16. (canceled)

17. A brazing furnace for use in brazing an object composed of an aluminum material, comprising:
a brazing chamber equipped with a heating apparatus that heats the object to a brazing temperature;
an inert gas supply apparatus that provides an inert gas;
a dehumidifying apparatus interposed in a gas supply line between the inert gas supply apparatus and the brazing chamber, the dehumidifying apparatus being configured to dehumidify of the inert gas by contacting the inert gas with a moisture absorbent that absorbs moisture in the inert gas prior to supplying the dehumidified inert gas into the brazing chamber; and
a regenerating device configured to remove moisture, which has absorbed in the moisture absorbent, from the moisture absorbent;
wherein the moisture absorbant is selected from the group consisting of silica gel, metal silicate, or zeolite.

18. The brazing furnace according to claim 17, wherein the brazing chamber and the dehumidifying apparatus are configured to maintain the dew point of the inert gas at −80° C. or lower while brazing the object at 600° C.

19. The brazing furnace according to claim 18, wherein:
the inert gas supply apparatus is configured to generate nitrogen gas by vaporizing liquid nitrogen; and
the dehumidifying apparatus is configured to reduce the dew point of the nitrogen gas to −80° C. or lower prior to supplying the dehumidified nitrogen gas to the interior of the brazing chamber.

20. The brazing furnace according to claim 19, wherein the dehumidifying apparatus further includes:
a branch portion in fluid communication with the inert gas supply apparatus;
first and second parallel gas flow paths in fluid communication with the branch portion; and
one or more flow path switch valves disposed in the branch portion and being configured selectively supply the nitrogen gas from the inert gas supply apparatus to either the first gas flow path or to the second gas flow path;
wherein the moisture absorbent comprises a first moisture absorbent disposed in the first gas flow path and a second moisture absorbent disposed in the second gas flow path.

21. The brazing furnace according to claim 20, wherein the regenerating device comprises:
a first heater that heats the first moisture absorbent;
a second heater that heats the second moisture absorbent; and
at least one regenerating pump in selective fluid communication with the first and second moisture absorbants and being configured to selectively degas the first and second moisture absorbants while the first or the second moisture absorbant is being selectively heated.

22. The brazing furnace according to claim 21, further comprising:
a preheating chamber connected to the brazing chamber and equipped with a preheating device that preheats the object to a temperature above 200° C. but lower than the brazing temperature,
a preheating pump configured to depressurize the interior of the preheating chamber to 100 Pa or less while the temperature of the object is above 200° C. but lower than the brazing temperature, and
a pressure-restoring gas supply apparatus configured to supply nitrogen gas from the inert gas supply apparatus to repressurize the interior of the preheating chamber after it has been heated and depressurized.

23. The brazing furnace according to claim 22, wherein the preheating pump, the preheating device and the preheating chamber are configured to depressurize the interior of the preheating chamber to 10 Pa or less while heating the preheating chamber to 300° C. or higher.
